(19) United States
(12) Patent Application Publication
(10) Pub. No.: US 2005/0271807 A1
(43) Pub. Date: Dec. 8, 2005

(54) Nano-extraction method and nano-condensation methods for guest molecules incorporation into single-wall carbon nanotube

(75) Inventors: Sumio Iljima, Aichi (JP); Kumiko Ajima, Ibaraki (JP); Masako Yudasaka, Ibaraki (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/895,955

(22) Filed: Jul. 22, 2004

(30) Foreign Application Priority Data
Jul. 23, 2003 (JP) 2003-200742

(51) Int. Cl. B05D 7/00

(52) U.S. Cl. 427/212

(57) ABSTRACT

The objects of this patent application are to provide a new nano-extraction method for guest molecules to be incorporated into single-wall carbon nanotube (SWNT) comprising: putting guest molecules in solvent, wherein the guest molecules have a poor affinity to the solvent and a strong affinity to single-wall carbon nanotube (SWNT) and the attractive force between the guest molecules and SWNT is greater than that between the guest molecules and solvent molecules and that between the solvent molecules and SWNT, ultrasonicating the solution including the solvent and quest molecules, adding single-wall carbon nanotube (SWNT) or single-wall carbon nanotubes (SWNTs) with opened tips and wall-holes in the solution, and leaving the SWNT-guest molecules-solvent mixture until becoming stable with the guest molecules incorporated into SWNT at room temperature, and a nano-condensation method for guest molecules to be incorporated into single-wall carbon nanotube (SWNT) comprising: dropping saturated solution including solvent and guest molecules having a strong affinity to the solvent and a strong affinity to single-wall carbon nanotube (SWNT) onto SWNT or SWNTs placed on a grid disk laid on filtration paper for sucking up the excess solution as quickly as possible.

### BACKGROUND OF THE INVENTION

1. Field of the Invention

The present invention relates a nano-extraction method and nano-condensation methods for guest molecules incorporation into single-wall carbon nanotube (SWNT). More specially, the present invention relates a nano-extraction method and nano-condensation methods for guest molecules incorporation into single-wall carbon nanotube, which can be used for drug delivery systems or other fields.

All of patents, patent applications, patent publications, scientific articles and the like, which will hereinafter be cited or identified in the present application, will, hereby, be incorporated by references in their entirety in order to describe more fully the state of the art, to which the present invention pertains.

2. Description of the Related Art

Single-wall carbon nanotubes (SWNTs) are nanometer-scale materials that are made of single-graphene sheets and have diameters of about 1 nm. They are chemically stable and mechanically robust, have interesting electronic properties, and their various applications have been investigated. When SWNTs having C₆₀ molecules inside, so called ‘peapods,” were discovered, it became apparent that SWNTs were attractive for applications apart from those taking advantage of the SWNTs' size, stability, and strength. The peapods have been found to be unique materials which enable us to study one-dimensional chemistry and physics. The peapods are also expected to be applied to drug delivery systems by replacing the C₆₀ by molecules having medicinal effects. To extend these avenues of research and application, methods of incorporating chemicals into various carbon nanotubes (CNTs), including SWNTs, need to be developed.

The C₆₀ peapods are typically prepared in the gas phase at 400° C. or higher, where C₆₀ molecules sublime and enter the SWNTs from the open ends or sidewall holes. This gas phase method is adequate only when the guest molecules are thermally stable and sublime or evaporate. This means the types of molecules to be incorporated into SWNTs are limited as long as depending on the gas-phase method. Most organic materials, especially chemicals with medical functions, degrade at elevated temperatures and neither evaporate nor sublime. Therefore, new methods of incorporating such molecules into SWNTs at room temperature are needed.

### SUMMARY OF THE INVENTION

The present invention firstly provides, as a means to solve the above-mentioned problems, a nano-extraction method for guest molecules to be incorporated into single-wall carbon nanotube (SWNT) comprising:
putting guest molecules in solvent, wherein the guest molecules have a poor affinity to the solvent and a strong affinity to single-wall carbon nanotube (SWNT) and the attractive force between the guest molecules and SWNT is greater than that between the guest molecules and solvent molecules and that between the solvent molecules and SWNT,
ultrasonicating the solution including the solvent and guest molecules,
adding single-wall carbon nanotube (SWNT) or single-wall carbon nanotubes (SWNTs) with opened tips and wall-holes in the solution,
and leaving the SWNT-guest molecules-solvent mixture until becoming stable with the guest molecules incorporated into SWNT at room temperature.

Also, the present invention secondly provides a nano-extraction method, wherein the guest molecules are any one of fullerenes, metal-containing fullerenes arid fullerenes with chemical modification by isomers or functional group. The invention thirdly provides a nano-extraction method, wherein the guest molecules are C₆₀s. And the present invention fourthly provides a nano-extraction method, wherein the solvent is ethanol.

Further, the present invention fifthly provides a nano-condensation method for guest molecules to be incorporated into single-wall carbon nanotube (SWNT) comprising: dropping saturated solution of guest molecules having solvent and guest molecules having a strong affinity to the solvent and a strong affinity to single-wall carbon nanotube (SWNT) onto SWNT or SWNTs placed on a grid disk laid on filtration paper for sucking up the excess solution as quickly as possible. The present invention sixthly provides a nano-condensation method, wherein the grid disk is made of metal and coated with amorphous-carbon (a-C).

The present invention seventhly provides a nano-condensation method for guest molecules to be incorporated into single-wall carbon nanotube (SWNT), comprising: dropping saturated solution including solvent and guest molecules having a strong affinity to the solvent and a strong affinity to single-wall carbon nanotube (SWNT) onto SWNT or SWNTs placed on a hot plate to dry, and not to sublime or evaporate the guest molecules and SWNTs.

Also, the present invention eighthly provides a nano-condensation method, wherein the guest molecules are any one of fullerenes, metal-containing fullerenes and fullerenes with chemical modification by isomers or functional group. The invention ninthly provides a nano-condensation method, wherein the guest molecules are C₆₀s. And the present invention tenthly provides a nano-condensation method, wherein the solvent is toluene.

### BRIEF DESCRIPTION OF THE DRAWINGS

FIG. 1A shows a conceptual diagram of an example of the nano-extraction method of this invention.

FIG. 1B shows a conceptual diagram of affinities between solvent and guest molecules and SWNT in the nano-extraction method of this invention.

FIG. 2A shows a conceptual diagram of an example of the nano-condensation method of this invention.

FIG. 2B shows a conceptual diagram of an example of the nano-condensation method of this invention.

FIG. 2C shows a conceptual diagram of affinities between solvent and guest molecules and SWNT in the nano-condensation method of this invention.

FIGS. 3(a), (b), (c) and (d) show the pictures of the examples of the nano-extraction method of this invention.

FIGS. 4(a), (b), (c) and (d) show the pictures of the examples of the nano-condensation method of this invention.

### DETAILED DESCRIPTION OF THE PREFERRED EMBODIMENTS

The present invention provides a nano-extraction method for guest molecules to be incorporated into single-wall carbon nanotube (SWNT), comprising: putting guest molecules in solvent, wherein the guest molecules have a poor affinity to the solvent and a strong affinity to single-wall carbon nanotube (SWNT) and the attractive force between the guest molecules and SWNT is greater than that between the guest molecules and solvent molecules and that between the solvent molecules and SWNT, ultrasonicating the solution including the solvent and guest molecules, adding single-wall carbon nanotube (SWNT) or single-wall carbon nanotubes (SWNTs) with opened tips and wall-holes in the solution, and leaving the SWNT-guest molecules-solvent mixture until becoming stable with the guest molecules incorporated into SWNT (ex. for 1 day), at room temperature.

Since this nano-extraction method is carried out in a liquid phase at room temperature, it is very useful for incorporation various material into SWNT, therefore, it would become very useful for drug delivery systems with the guest molecules having medicinal effect or other fields.

Also, this nano-extraction method would be preferably applied when the guest molecules are any one of fullerenes such as C₆₀, C₇₀, C₇₆, C₇₈, C₈₂, C₈₄, C₉₀, C₉₄ or C₉₆, metal-containing fullerenes and fullerenes with chemical modification by isomers or functional group. Especially, this nano-extraction would be more preferably applied when the guest molecules are C₆₀s. Also, this nano-extraction method can be preferably used with ethanol as the solvent.

Further, the present invention provides a nano-condensation method for guest molecules to be incorporated into single-wall carbon nanotube (SWNT), comprising: dropping saturated solution including solvent and guest molecules having a strong affinity to the solvent and a strong affinity to single-wall carbon nanotube (SWNT) onto SWNT or SWNTs placed on a grid disk laid on filtration paper for sucking up the excess solution as quickly as possible. And the grid disk would be preferably made of metal such as Cu and coated with amorphous-carbon (a-C).

Also, the present invention provides a nano-condensation method for guest molecules to be incorporated into single-wall carbon nanotube (SWNT), comprising: dropping saturated solution including solvent and guest molecules having a strong affinity to the solvent and a strong affinity to single-wall carbon nanotube (SWNT) onto SWNT or SWNTs placed on a hot plate whose temperature is controlled to dry the solution instantly and not to evaporate or sublime the guest molecules and SWNTs.

Since these nano-condensation methods are carried out in a liquid phase at room temperature and they can be completed within a few seconds, they are very useful for incorporation various material into SWNT and would become very useful for drug delivery systems with the guest molecules having medicinal effect or other fields.

These nano-condensation methods would be preferably applied when the guest molecules are any one of fullerenes such as C₆₀, C₇₀, C₇₆, C₇₈, C₈₂, C₈₄, C₉₀, C₉₄ or C₉₆, metal-containing fullerenes and fullerenes with chemical modification by isomers or functional group.

Especially, these nano-condensation methods would be more preferably applied when the guest molecules are C₆₀s. And these nano-condensation methods can be preferably used with toluene as the solvent.

The incorporation mechanisms of above-mentioned methods are similar to those of two conventional methods widely used in chemistry—extraction and condensation—so the above-mentioned methods are called “nano-extraction” and nano-condensation.”

Since these nano-extraction method and nano-condensation methods are carried out in a liquid phase at room temperature, they are useful for incorporating various materials into SWNT and other nanometer-scale materials if an appropriate solvent is used. The nano-condensation methods are especially useful because they can be completed within a few seconds.

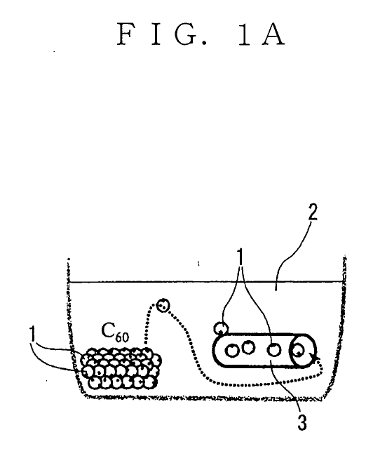

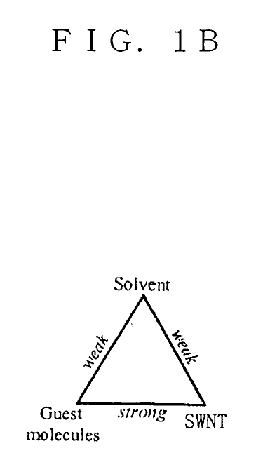

For this nano-extraction method to succeed, the guest molecules need to replace the solvent inside the tube walls. In nano-extraction, guest molecules must have poor affinity to the solvent but a strong affinity to the SWNT. Also, the solvent must have a poor affinity to SWNT as shown in FIG. 1(b). And for example, as shown FIG. 1(a), the inventors put C₆₀ crystallites (1) into ethanol (2), ultrasonicate (bath type) the solution, add SWNTs (3), and leave this SWNT-C₆₀-ethanol mixture until becoming stable with the C₆₀ crystallites (1) incorporated into SWNTs (3) at room temperature.

The solubility of C₆₀ in ethanol is about 0.001 mg/ml so most of the C₆₀ crystallites (1) did not dissolve in ethanol (2), instead remaining at the bottom of the ethanol (2) or suspended in the ethanol (2).

For this to happen, the attractive forces between the three materials must be appropriately balanced as shown in FIG. 1(b): the attractive force between the guest molecules and SWNT must be greater than that between the guest molecules and solvent molecules and that between the solvent molecules and SWNT. If these conditions are satisfied, the guest molecules will be deposited within the SWNT. The guest molecules will probably find the most stable sites for deposition to be inside SWNT and gather there. When toluene is used instead of ethanol in the above case, the nano-extraction does not work, perhaps because the C₆₀-toluene and/or SWNT-toluene interactions are stronger than the C₆₀-SWNT interaction. Also, the guest molecules must have a poor affinity to the solvent, otherwise, the guest molecules are too dissolved in the solvent and they can not be incorporated in SWNT.

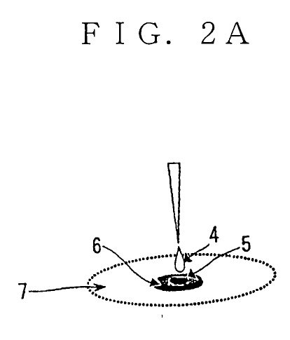

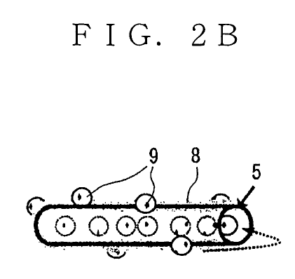

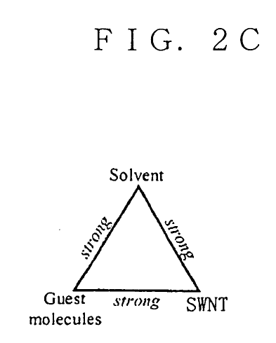

On the other hand, the nano-condensation mechanism is difficult to understand. Competing processes are the adsorption of solvent molecules on the tube wall, evaporation of solvent molecules, segregation or self-crystallization of the guest molecules, and deposition of the guest molecules inside the tube walls. In the C₆₀-toluene-SWNT cases, as shown in FIG. 2(a), the C₆₀-toluene solution (4) remained on the SWNTs (5) surfaces on the grid disk (6) after the solution is absorbed by the filtration paper (7), and toluene formed thin toluene-layer (8) covering the inside and outside of the tube walls as shown in FIG. 2(b). The C₆₀ molecules (9) are weakly bound to the thin toluene-layer (8) and SWNT wall via the van der Waals force, migrated through the thin toluene-layer (8), and eventually deposited themselves at the most stable sites for C₆₀ molecules (9); that is, inside the SWNT (5), since the C₆₀ molecules (9) are bound to the thin toluene-layer (a), this might be prevented three-dimensional crystallization of the C₆₀.

For example, the inventors' tentative model for the nano-condensation mechanism explains the failure of (C₆₀)ₙ@SWNT formation when the C₆₀-toluene-SWNT mixture is slowly dried on the TEM grid. Before the drying, the inside of each tube might be occupied by toluene, meaning that the C₆₀ molecules would be stably surrounded by toluene molecules outside the SWNT. As the toluene evaporated, C₆₀ molecules would segregate outside the tubes and crystallized. After drying, the toluene molecules would remain adsorbed on the tube wall, but most of the C₆₀ molecules would be already crystallized and few of them would migrate through this toluene layer; thus, there would be little or no incorporation of C₆₀ molecules inside SWNT.

According to the inventors' tentative model, a thin layer of C₆₀-toluene is needed for successful nano-condensation. To form such layers, an ‘instant touch’ of SWNTs with a C₆₀-toluene solution would be necessary. As an alternative to using filtration paper to quickly remove the extra solution, the inventors tried passing a drop of solution through SWNTs supported on a thin metal wire. The inventors also tried dropping the C₆₀-toluene solution onto a SWNT/TEM specimen-holder placed on a hot plate kept at about 180° C. so that the solution would be instantly dried. In both cases, C₆₀ was incorporated inside the tubes and (C₆₀)ₙ@SWNTs were formed.

In addition to the instant-touch technique, nano-condensation requires the solvent to have a strong affinity to both the guest molecules and the SWNT (FIG. 2(c)). The former is necessary so that a large number of the guest molecules will remain on the tube surface (FIG. 2(b)), and the latter is needed to generate the thin solvent layers (FIG. 2(b)). The affinity between guest molecules and SWNT should also be high to stabilize their coexistence. Neither of the first two conditions is satisfied when the C₆₀-ethanol saturated solution is used, so no C₆₀ molecule is incorporated into the SWNT.

Nano-extraction and nano-condensation are both useful for incorporating guest molecule such as C₆₀ molecules inside SWNT. The processes are easy to apply and require no special skill; nano-condensation is especially convenient because the process finishes quickly. The inventors believe that these methods can be used to incorporate various guest molecules into SWNT and other CNT if appropriate solvents are found. The two methods might also be applicable to other nanometer-scale materials that contain vacant spaces and have holes wide enough for the guest molecules to pass through.

### EXAMPLE

### Example 1

At first, the inventors heat-treated HiPco SWNTs (Carbon Nanotechnologies Incorporated) at 1780° C. in vacuum (1×10⁻⁶ Torr) for 5 hours, and further heat-treated them in an oxygen atmosphere at 570° C. for about to minutes. The 1780° C. heat treatment enlarged the tube diameters from 1 nm or less to 1 nm or more (about 50% of them had diameters larger than 2 nm), and the Fe content was reduced from about 30% to almost 0%. After the 570° C. oxygen-gas treatment, the tips of the SWNTs were open and holes had been pierced through the sidewalls.

In nano-extraction, guest molecules must have poor affinity to the solvent but a strong affinity to the SWNT. Also, the solvent must have a poor affinity to SWNT. As shown in FIG. 1(a), to demonstrate nano-extraction, the inventors put C₆₀ crystallites (1) (1 mg) into ethanol (2) (10 ml), ultrasonicated (bath type) the solution for 3 minutes, added SWNTs (3) (1 mg), and this SWNT-C₆₀-ethanol mixture for 1 day at room temperature.

The solubility of C₆₀ in ethanol is about 0.001 mg/ml so most of the C₆₀ crystallites (1) did not dissolve in ethanol (2), instead remaining at the bottom of the ethanol (2) or suspended in the ethanol (2).

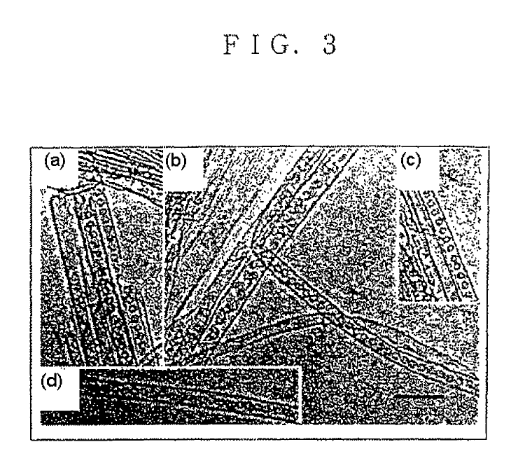

After 1 day, the inventors took SWNTs out of the SWNT-C₆₀-ethanol mixture and dried them in air at room temperature. Transmission electron microscope (TEM) observation had shown that the initial SWNTs were empty (not shown); however, as a result of the nano-extraction, C₆₀ molecules were incorporated inside the SWNTs (C₆₀)ₙ@SWNTs as shown in FIG. 3.

The inventors found that the C₆₀ molecules aligned inside the SWNTs by taking various configurations depending on whether the tube diameters were 1 nm or larger; these configurations were a single-chain phase (FIG. 3(c)), zigzag phases (FIGS. 3(a), 3(b), and 3(d), and double-chain-like arrangements (FIG. 3(b)). Open caps can also be seen in FIG. 3(a) with the C₆₀ molecules packed up to the very entrance.

If the solvent has a strong affinity to the guest molecules and SWNT, nano-extraction does not work. For example, toluene has a strong affinity to C₆₀ molecules and SWNT and the Inventors' attempt at nano-extraction using these three materials failed: few C₆₀ molecules were incorporated into the SWNT.

### Example 2

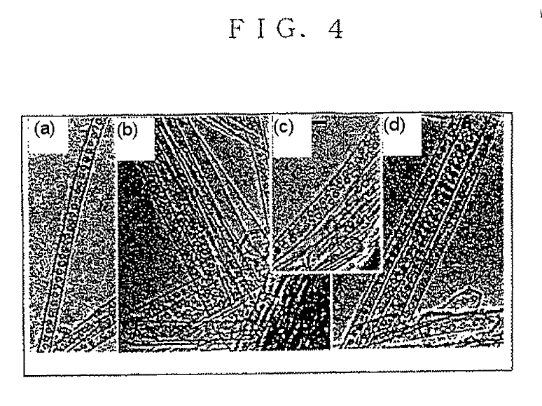

To prepare (C₆₀)ₙ@SWNTs through nano-condensation, as shown in FIG. 2(a) the inventors dropped about 10 μl of C₆₀-toluene saturated solution (4) (2.8 mg/ml [17]) onto SWNTs (5) placed on a grid disk (6) (a TEM sample-holder) laid on filtration paper (7). The grid disk (6), which was about 3 mm in diameter and about 0.05 mm thick, was made of Cu and coated with a-C. The purpose of the filtration paper (7) was to suck up the excess solution as quickly as possible. After these processes, the inventors observed the specimens by TEM, and found that (C₆₀)ₙ@SWNTs had been obtained as shown in FIG. 4. The C₆₀-molecule arrangements inside the tubes were the single-chain phase (FIGS. 4(a) and 4(b)) and the double-helix phase (FIG. 4(c)). The inventors could also see C₆₀ molecules arranged in a tetragonal-like manner in FIG. 4(d), where the actual arrangement of the C₆₀ molecules was not entirely clear. To show the importance of the filtration paper's rote in preparing (C₆₀)ₙ@SWNTs through nano-condensation, the inventors dropped 10 μl of (C₆₀)-toluene saturated solution onto the TEM grid, and then held the TEM grid with tweezers while letting the sample dry at room temperature. Because no filtration paper was used, the sample took 2 to 3 minutes to dry. TEM observation of the specimen thus prepared indicated that few (C₆₀) molecules were incorporated into the SWNTs (not shown).

The inventors estimated from TEM images that about 50 to 70% of SWNTs had (C₆₀) molecules in their insides as shown in FIGS. 3 and 4. It seems that the filling efficiency will be increased by optimizing the conditions for opening the ends and wall-holes of SWNTs.

As explained in detail above, the present invention provides novel nano-extraction method and nano-condensation methods for guest molecules incorporation into single-wall carbon nanotube, which can be used for drug delivery systems or other fields.

1. A nano-extraction method for guest molecules to be incorporated into single-wall carbon nanotube (SWNT), comprising:
putting guest molecules in solvent, wherein the guest molecules have a poor affinity to the solvent and a strong affinity to single-wall carbon nanotube (SWNT) and the attractive force between the guest molecules and SWNT is greater than that between the guest molecules and solvent molecules and that between the solvent molecules and SWNT,
ultrasonicating the solution including the solvent and guest molecules,
adding single-wall carbon nanotube (SWNT) or single-wall carbon nanotubes (SWNTs) with opened tips and wall-holes in the solution,
and leaving the SWNT-guest molecules-solvent mixture until becoming stable with the guest molecules incorporated into SWNT at room temperature.

2. A nano-extraction method according to claim 1, wherein the guest molecules are any one of fullerenes, metal-containing fullerenes and fullerenes with chemical modification by isomers or functional group.

3. A nano-extraction method according to claim 2, wherein the guest molecules are C₆₀s.

4. A nano-extraction method according to any one of claims 1 or 3, wherein the solvent is ethanol.

5. A nano-condensation method for guest molecules to be incorporated into single-wall carbon nanotube (SWNT) comprising:
dropping saturated solution including solvent and guest molecules having a strong affinity to the solvent and a strong affinity to single-wall carbon nanotube (SWNT) onto SWNT or SWNTs placed on a grid disk laid on filtration paper for sucking up the excess solution as quickly as possible.

6. A nano-condensation method according to claim 5, wherein the grid disk is made of metal and coated with amorphous-carbon (a-C).

7. A nano-condensation method for guest molecules to be incorporated into single-wall carbon nanotube (SWNT) comprising:
dropping saturated solution including solvent and guest molecules having a strong affinity to the solvent and a strong affinity to single-wall carbon nanotube (SWNT) onto SWNT or SWNTs placed on a hot plate whose temperature is controlled to dry the solution instantly and not to sublime or evaporate the guest molecules and SWNTs.

8. A nano-condensation method according to any one of claims 5 or 7, wherein the guest molecules are any one of fullerenes, metal-containing fullerenes and fullerenes with chemical modification by isomers or functional group.

9. A nano-condensation method according to claim 8, wherein the guest molecules are C₆₀s.

10. A nano-condensation method according to any one of claims 5 or 9, wherein the solvent is toluene.
